(19) United States
(12) Patent Application Publication
(10) Pub. No.: US 2026/0168785 A1
(43) Pub. Date: Jun. 18, 2026

(54) THREE-DIMENSIONAL MORPHOLOGY DETECTION DEVICE AND MEASUREMENT METHOD FOR DETERMINING DEPTH OF HIGH ASPECT RATIO MICROSTRUCTURES THEREOF

(71) Applicant: INDUSTRIAL TECHNOLOGY RESEARCH INSTITUTE, Hsinchu (TW)

(72) Inventors: Cheng-Kang LEE, Hsinchu City (TW); Chia-Liang YEH, Zhubei City (TW); Yi-Sha KU, Hsinchu City (TW); Chun-Wei LO, Taichung City (TW)

(73) Assignee: INDUSTRIAL TECHNOLOGY RESEARCH INSTITUTE, Hsinchu (TW)

(21) Appl. No.: 19/000,060

(22) Filed: Dec. 23, 2024

(30) Foreign Application Priority Data
Dec. 13, 2024 (TW) 113148696

(51) Int. Cl. G01B 11/03

(52) U.S. Cl. CPC G01B 11/03

(57) ABSTRACT

A three-dimensional morphology detection device includes a photosensitive element and a measurement mechanism. The photosensitive element is to provide detection images of a sample. The measurement mechanism is to provide a sample light to achieve 3D morphology imaging of the sample onto the photosensitive element. The measurement mechanism includes an objective lens to provide detection images of the sample to the photosensitive element, and further includes, in the same horizontal direction, a beam splitter, a detection light source, a beam collimating element and a light reflecting element. The beam splitter is to split a collimated light beam into a reference light and the sample light and to superimpose phases of the reference light and the sample light after reflection, thereby introducing interference fringes in the detection images of the sample. The light reflecting element is to reflect the reference light for reception by the beam splitter.

### TECHNICAL FIELD

This disclosure relates to a three-dimensional morphology detection device and a measurement method for determining depth of high aspect ratio microstructures thereof.

### BACKGROUND

As shown in FIG. 1 and FIG. 2, FIG. 1 is a partial top view of a TSV sample S1, and FIG. 2 is a partial cross-sectional view of the TSV sample S1 in FIG. 1. In advanced manufacturing processes, Through Silicon Via (TSV) technology is used to construct high aspect ratio (HAR) stacks to meet the demands of future high-performance computing (HPC). This technology is applied in 3D IC designs for Apple chips and NVIDIA AI chips, enabling more compact semiconductor packaging structures.

As shown in FIG. 3 and FIG. 4, FIG. 3 is a partial perspective view of a surface of a metalens sample S2, and FIG. 4 is a partial cross-sectional view of the metalens sample S2 in FIG. 3. A metalens utilizes millions of nano-pillars N1 to precisely control the propagation direction of light. When the aspect ratio (AR) of the nano-pillars N1 increases, the optical diffraction efficiency of the metalens correspondingly improves, enabling lower aberrations and higher numerical aperture (NA) resolution capabilities. As shown in FIG. 3 and FIG. 4, the nano-pillars N1 feature high aspect ratio holes V2, where the depth of the holes V2 may be equal to the length of the nano-pillars N1, or the depth of the holes may be less than the length of the nano-pillars, and the metalens sample S2 has a complex three-dimensional morphology.

For products having high aspect ratio microstructures such as the aforementioned through silicon vias and metalenses, the market demand for precision inspection and analysis of their microstructures is rapidly increasing. Such inspection not only improves the production yield of metalenses and semiconductor packaging but also effectively reduces manufacturing costs, increasing both technological and economic benefits.

Common three-dimensional morphology measurement techniques include reflectometry and white-light interferometry. Reflectometry can measure high aspect ratio microstructures but is limited to providing the average value of all holes within the measurement range. In contrast, white-light interferometry serves as a global measurement technique, capable of measuring the entire three-dimensional morphology of the sample within the field of view.

Common white-light interferometers include the Michelson type, Mirau type, and Linnik type. These systems utilize microscope magnification techniques to achieve sub-nanometer measurement precision, thereby suitable for semiconductor-related inspection applications, such as wafer bumping and post-coating surface roughness measurements. However, in conventional white-light interferometers, the detection light beam must first converge through the objective lens before reaching the sample surface, so the conventional white-light interferometers are only applicable for measuring the three-dimensional morphology of high aspect ratio samples with hole widths greater than 15 micrometers (μm or um). For high aspect ratio samples with hole widths less than 15 micrometers, the converged light beam of the conventional white-light interferometers is often interfered by the inner sidewalls of the holes before reaching the bottom of the holes of the sample. Consequently, the light beam cannot effectively reach the bottom of the holes, making it impossible to achieve accurate measurements of such high aspect ratio samples.

### SUMMARY

The present disclosure is to provide a three-dimensional morphology detection device and a measurement method for determining depth of high aspect ratio microstructures thereof capable of achieving accurate measurements of such high aspect ratio samples.

One embodiment of the disclosure provides a three-dimensional morphology detection device configured to inspect a three-dimensional morphology of a sample. The three-dimensional morphology detection device includes a photosensitive element and a measurement mechanism. The photosensitive element is configured to provide detection images of the sample, and the measurement mechanism is configured to provide a sample light to the sample to achieve three-dimensional morphology imaging of the sample onto the photosensitive element. The measurement mechanism includes an objective lens, a beam splitter, a detection light source, a beam collimating element and a light reflecting element. The objective lens is configured to converge light and provide detection images of the sample to the photosensitive element. The beam splitter is located between the objective lens and the sample and configured to split a collimated light beam into a reference light and the sample light and to superimpose phases of the reference light after reflection and the sample light reflected from the sample, thereby introducing interference fringes in the detection images of the sample. The detection light source and the objective lens are located on two adjacent sides of the beam splitter. The beam collimating element is located between the detection light source and the beam splitter and configured to collimate a light beam emitted by the detection light source. The light reflecting element and the detection light source are located on opposite sides of the beam splitter, and the light reflecting element is configured to reflect the reference light for reception by the beam splitter.

One embodiment of the disclosure provides a measurement method for determining depth of high aspect ratio microstructures including directing the sample light of the aforementioned three-dimensional morphology detection device to a sample; positioning the sample on a focal plane of the three-dimensional morphology detection device and adjusting an image formed on the photosensitive element to display interference fringes; performing vertical scanning by moving the three-dimensional morphology detection device along Z-axis using a piezoelectric transducer; and analyzing the interference fringes of images captured at various depths along Z-axis to obtain surface height data of microstructures at different depths of the sample. In addition, the sample light that is directed to the sample has a convergence angle of less than 7 degrees.

One embodiment of the disclosure provides a three-dimensional morphology detection device including a detection light source, a beam collimating element, a beam splitter, a light reflecting element, an objective lens and a photosensitive element. The detection light source is configured to provide a light beam. The beam collimating element is configured to collimate the light beam from the detection light source. The beam splitter is configured to split a collimated light beam into a reflected light beam and a transmitted light beam and to receive a sample light traveling in an opposite direction to the reflected light beam and a reference light traveling in an opposite direction to the transmitted light beam. The light reflecting element is configured to reflect the transmitted light beam and provide the reference light. The objective lens is configured to transmit the sample light. The photosensitive element is configured to receive the sample light from the objective lens to provide a detection image of a sample, where the detection image displays interference fringes. In addition, the detection light source, the beam collimating element, the beam splitter and the light reflecting element are arranged in a same horizontal direction, the objective lens is arranged between the photosensitive element and the beam splitter in a vertical direction, and the vertical direction is perpendicular to the horizontal direction.

According to the three-dimensional morphology detection device and the measurement method for determining depth of high aspect ratio microstructures as described above, since the sample light split from the beam splitter is directly directed to the sample without first passing through the objective lens, which is configured for focusing light, the sample light is substantially a parallel beam. By directing a parallel sample light to the sample, the sample light can effectively reach the bottom of the holes of the sample featuring high aspect ratio microstructures, enabling precise measurement of the three-dimensional morphology of the sample.

In addition, experimental measurement results demonstrate that the three-dimensional morphology detection device of the disclosure can accurately measure the three-dimensional morphology of high aspect ratio samples with hole widths smaller than 10 micrometers. In contrast, conventional Michelson-type interferometers are limited to measuring the three-dimensional morphology of high aspect ratio samples with hole widths larger than 15 micrometers. Accordingly, the three-dimensional morphology detection device of the disclosure can measure the three-dimensional morphology of samples with significantly greater precision compared to conventional Michelson-type interferometers.

The foregoing description of the present disclosure and the detailed description given hereinbelow are provided to demonstrate and explain the principles of the disclosure, as well as to offer further clarification of the scope of the claims.

### BRIEF DESCRIPTION OF THE DRAWINGS

FIG. 1 is a partial top view of a TSV sample;

FIG. 2 is a partial cross-sectional view of the TSV sample in FIG. 1;

FIG. 3 is a partial perspective view of a surface of a metalens sample;

FIG. 4 is a partial cross-sectional view of the metalens sample in FIG. 3;

FIG. 5 is partial side view of a three-dimensional morphology detection device in accordance with one embodiment of the disclosure;

FIG. 6 is a schematic view of the three-dimensional morphology detection device in FIG. 5 and a sample;

FIG. 7 is a measurement signal diagram of the three-dimensional morphology detection device in FIG. 5 when measuring the TSV sample;

FIG. 8 is a measurement result diagram derived from the analysis of the measurement signal in FIG. 7;

FIG. 9 is a measurement signal diagram of a conventional Michelson-type interferometer when measuring the TSV sample;

FIG. 10 is a measurement result diagram derived from the analysis of the measurement signal in FIG. 9; and

FIG. 11 is a comparison diagram of grayscale values of images obtained by measuring the TSV sample using the three-dimensional morphology detection device of the disclosure and the conventional Michelson-type interferometer.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

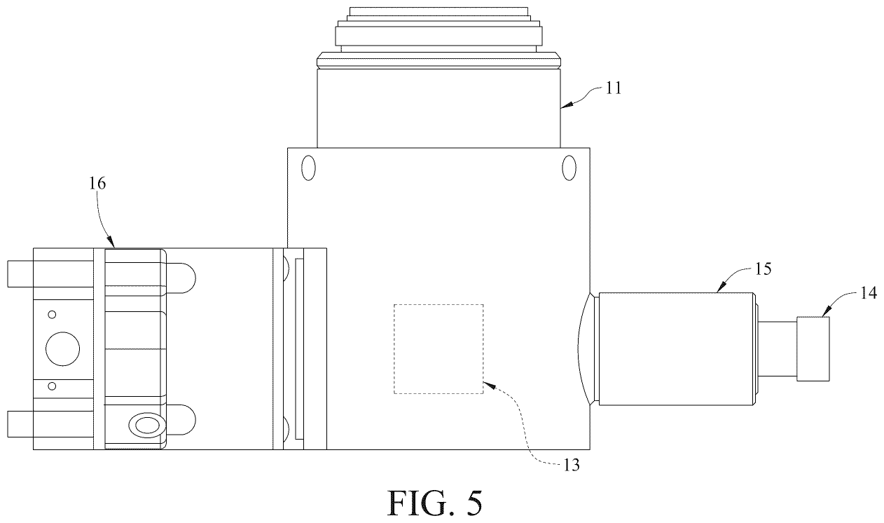

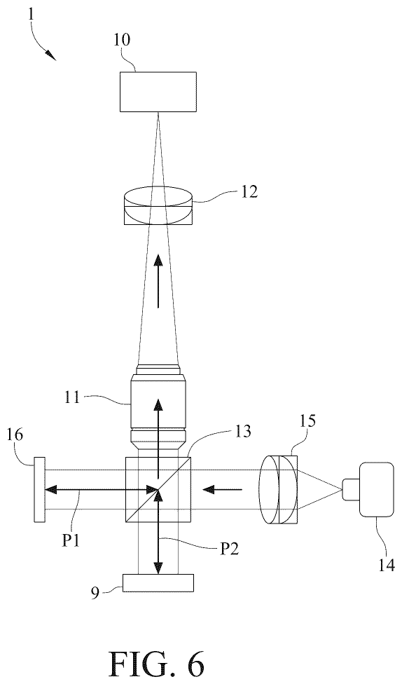

The disclosure provides a three-dimensional morphology detection device. In some embodiments, the three-dimensional morphology detection device of the disclosure utilizes image interferometry technology to measure the depth of each TSV in a three-dimensional morphology, which may also be referred to as global measurement of the depth of the TSVs. The three-dimensional morphology detection device of the disclosure can measure microstructures with three-dimensional morphology, such as TSVs or metalenses with hole widths less than 10 micrometers. Furthermore, high aspect ratio microstructures refer to those with a hole depth-to-width ratio (depth D:width W) ranging from 6:1 to 10:1 (commonly referred to as high aspect ratio). Referring to FIG. 5 and FIG. 6, FIG. 5 is partial side view of a three-dimensional morphology detection device in accordance with one embodiment of the disclosure, and FIG. 6 is a schematic view of the three-dimensional morphology detection device in FIG. 5 and a sample.

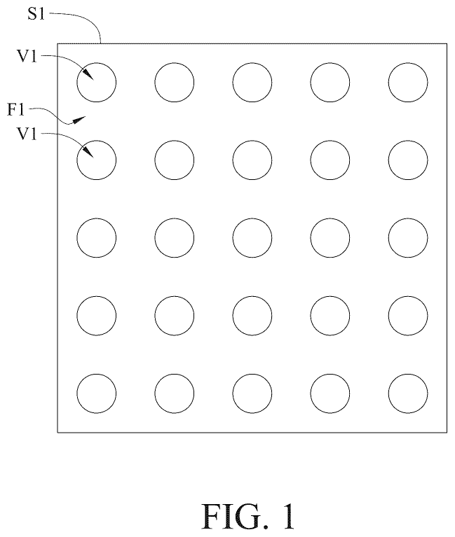

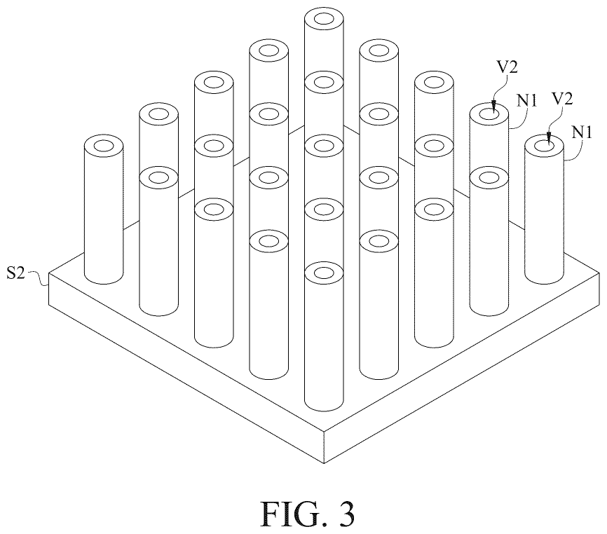

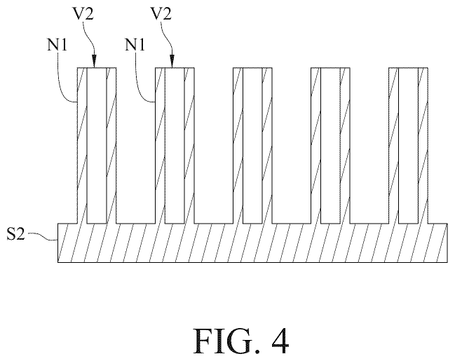

In this embodiment, a three-dimensional morphology detection device 1 is provided. The three-dimensional morphology detection device 1 is configured to inspect microstructures with three-dimensional morphology on a surface of a sample 9. The sample 9 may be TSVs or a metalens with high aspect ratio microstructures, as shown in FIG. 1 to FIG. 4. In this embodiment, the sample 9 is a TSV sample having TSVs with hole widths less than 10 micrometers, and the three-dimensional morphology detection device 1 can provide a parallel beam or a light beam with a convergence angle of less than 7 degrees to measure the hole depth of each TSV. The details are as follows:
As shown in FIG. 6, in this embodiment, the three-dimensional morphology detection device 1 includes a photosensitive element 10 and a measurement mechanism. The photosensitive element 10 is configured to provide detection images of the sample 9. The measurement mechanism is configured to provide a sample light to the sample 9 to achieve three-dimensional morphology imaging of the sample 9 onto the photosensitive element 10. In addition, the measurement mechanism includes a beam splitter 13, a detection light source 14, a beam collimating element 15 and a light reflecting element 16 arranged in a same horizontal direction, and further includes an objective lens 11 arranged between the photosensitive element 10 and the beam splitter 13 in a vertical direction, where the vertical direction is perpendicular to the horizontal direction, but the disclosure is not limited thereto. The three-dimensional morphology detection device 1 further includes a tube lens 12 arranged between the objective lens 11 and the photosensitive element 10.

In this embodiment, based on the arrangement of the components, the beam splitter 13 is arranged between the objective lens 11 and the sample 9, the detection light source 14 and the light reflecting element 16 are arranged on opposite sides of the beam splitter 13, and the beam collimating element 15 is arranged between the beam splitter 13 and the detection light source 14.

Specifically, each component functions collaboratively based on its designated role to achieve the measurement of hole depths of the TSVs. The objective lens 11 can form a parallel beam at a back focal plane (BFP) to transmit the parallel beam to the tube lens 12. The tube lens 12 is arranged between the photosensitive element 10 and the objective lens 11 and configured to focus the parallel beam to form a clear image of interference fringes. The tube lens 12 compensates for potential residual field curvature, coma, or axial chromatic aberration of the objective lens 11, thereby providing sharp digital images. Additionally, a focal length of the tube lens 12 (typically ranging from 180 mm to 250 mm; e.g., 180 mm or 200 mm) is designed to match the specifications of the objective lens 11.

Furthermore, based on the light path (or referred to as the optical path) detected by the photosensitive element 10, it can be seen that the beam splitter 13, the detection light source 14, the beam collimating element 15 and the light reflecting element 16 are arranged in the same horizontal direction. Since the divergent light (or referred to as the incident light) provided by the detection light source 14 is positioned at a focal point of the beam collimating element 15, the beam collimating element 15 can transform the divergent light or non-parallel light beam into a collimated light beam (e.g., a nearly parallel light beam). The beam splitter 13 is configured to separate or redirect the collimated light beam, splitting it into optical paths of different wavelengths or directions, and providing a light beam of specific wavelength or direction to the light reflecting element 16. The light reflecting element 16 receives the light beam of a specific wavelength or direction, adjusts its optical path direction, and transmits the adjusted light beam to the photosensitive element 10 for inspection or imaging.

The photosensitive element 10 may be, for example, an area imaging mechanism of visible light detection or other wavelength bands. For instance, the photosensitive element 10 may be a charge-coupled device (CCD) sensor array or a complementary metal-oxide-semiconductor (CMOS) sensor array.

The objective lens 11 is located between the photosensitive element 10 and the sample 9, and the objective lens 11 is configured to converge light and provide detection images of the sample 9 to the photosensitive element 10. In addition, the objective lens 11 is, for example, a microscope objective lens, and a numerical aperture of the objective lens 11 may, for example, range from 0.1 to 1.4.

The tube lens 12 is located between the objective lens 11 and the photosensitive element 10. Specifically, the tube lens 12 may, for example, be disposed in a tube (not shown) that connects the objective lens 11 and the photosensitive element 10. The tube lens 12 can work in conjunction with the objective lens 11 to magnify the image and project it onto the photosensitive element 10. The tube lens 12 may also be referred to as an auxiliary lens. However, the tube lens 12 can be optional, and the disclosure is not limited thereto. In some embodiments of the disclosure, the three-dimensional morphology detection device may not be provided with a tube lens.

The beam splitter 13 is located between the objective lens 11 and the sample 9, and the beam splitter 13 is configured for beam splitting and beam combining, enabling the light beams to interfere. Specifically, the beam splitter 13 is configured to split a single incident light beam into two light beams (which are typically a reflected light beam and a transmitted light beam). The two light beams propagate along different optical paths (e.g., a sample optical path and a reference optical path) within the three-dimensional morphology detection device 1. Additionally, the two light beams can recombine at the beam splitter 13 and undergo phase superposition, forming a detection image containing interference signals on the photosensitive element 10. Moreover, the beam splitter 13 can be, for example, a cube beam splitter or a plate beam splitter.

The detection light source 14 and the objective lens 11 are located on two adjacent sides of the beam splitter 13. In other words, as shown in FIG. 6, the objective lens 11 is not located between the detection light source 14 and the sample 9 in a travelling path of the light beam. In addition, the detection light source 14 is configured to emit a light beam, the detection light source 14 may be a detection broadband light source, and the light beam from the detection light source 14 can be a broadband white light or a broadband light of other wavelength ranges.

The beam collimating element 15 is located between the detection light source 14 and the beam splitter 13, and configured to collimate the light beam from the detection light source 14. Additionally, the beam collimating element 15 may be, for example, an aspherical mirror or a multifaceted mirror collimator.

The light reflecting element 16 and the detection light source 14 are located on opposite sides of the beam splitter 13, and the light reflecting element 16 is configured to reflect light. Additionally, the light reflecting element 16 may be, for example, a reference surface reflector.

Through the above configuration, the beam splitter 13 is configured to split the collimated light beam into a reference light and a sample light. The reference light travels along a reference optical path P1, is directed to the light reflecting element 16, and is reflected by the light reflecting element 16. The sample light travels along a sample optical path P2, is directed to the sample 9, and is reflected by the sample 9. The reference light reflected by the light reflecting element 16 and the sample light reflected by the sample 9 recombine at the beam splitter 13 and undergo phase superposition, and then pass through the objective lens 11 to produce an image containing interference signals (or interference fringes) on the photosensitive element 10.

Since the sample light split from the beam splitter 13 is directly directed to the sample 9 without first passing through the objective lens 11, which is configured for focusing light, the sample light is substantially a parallel beam. By directing a parallel sample light to the sample 9, the sample light can effectively reach the bottom of the holes of the sample 9 featuring high aspect ratio microstructures, enabling precise measurement of the three-dimensional morphology of the sample 9. The sample light being substantially a parallel beam may refer to a state where a convergence angle of the sample light is less than 7 degrees, approximating a parallel beam, which means that the disclosure is not limited to the sample light being an ideally parallel beam with a convergence angle of exactly 0 degree. Due to factors such as manufacturing tolerances of components, the sample light may be close to parallel. In the present disclosure, the term “parallel beam” should be interpreted as either a light beam with a convergence angle of 0 degree (ideal parallel beam) or a light beam with a convergence angle of less than 7 degrees that approximates a parallel beam.

The following describes a measurement method for determining depth of high aspect ratio microstructures using the aforementioned three-dimensional morphology detection device 1.

First, direct the sample light of the three-dimensional morphology detection device 1 to the sample 9, where the sample light has a convergence angle of less than 7 degrees. Next, position the sample 9 on a focal plane of the three-dimensional morphology detection device 1 and adjust an image formed on the photosensitive element 10 to display interference fringes. Then, perform vertical scanning by moving the three-dimensional morphology detection device 1 along Z-axis using a piezoelectric transducer (PZT). Finally, analyze the interference fringes of images captured at various depths along Z-axis to obtain surface height data of the microstructures at different depths of the sample 9.

Through the above measurement method for determining depth of high aspect ratio microstructures using the three-dimensional morphology detection device 1, the sample light can effectively reach the bottom of the holes of the sample 9 featuring high aspect ratio microstructures, enabling precise measurement of the three-dimensional morphology of the sample 9.

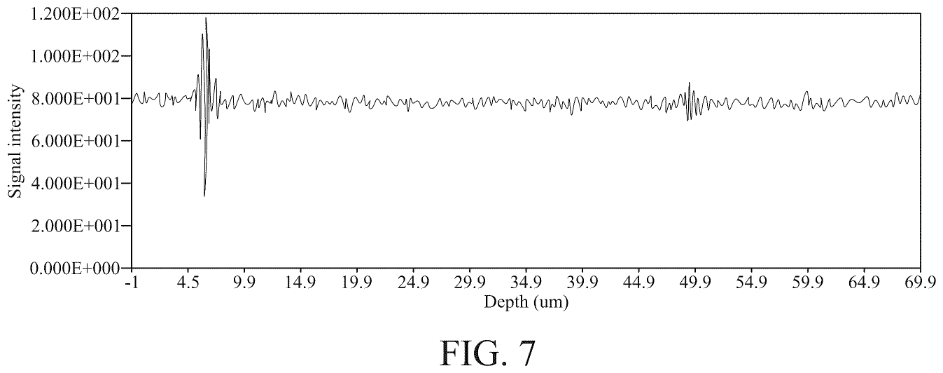

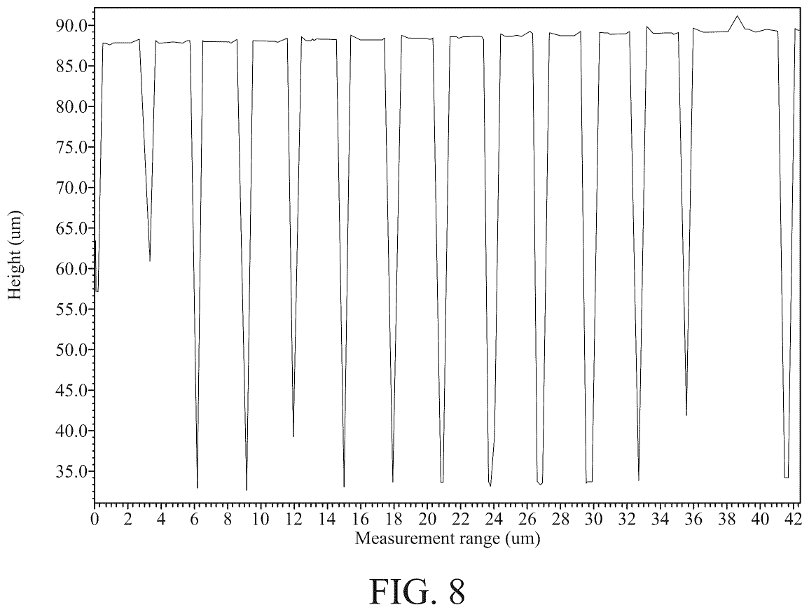

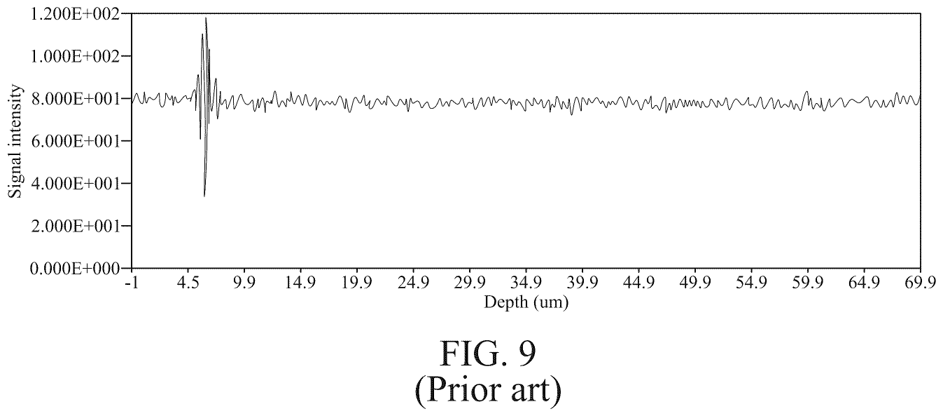

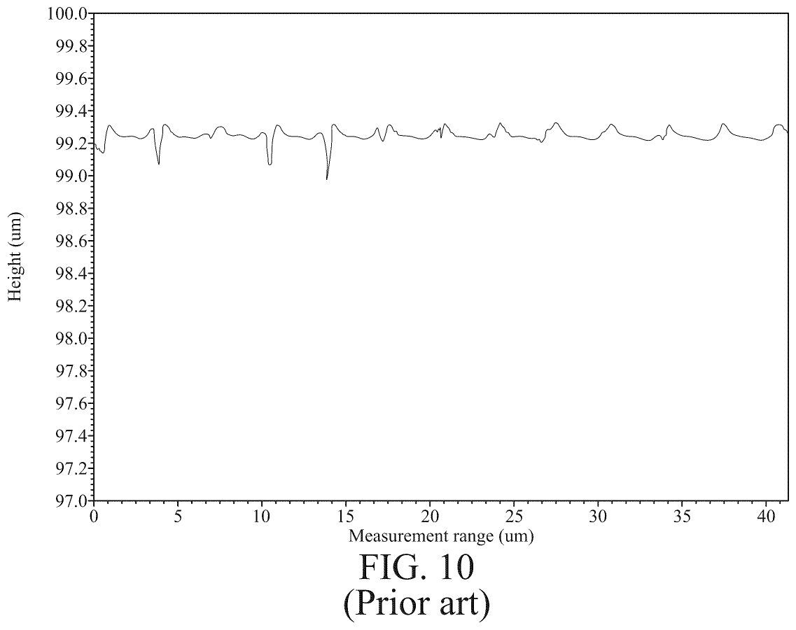

As an example, when measuring a TSV sample having TSVs with hole widths of 10 micrometers and hole depths of 50 micrometers, the three-dimensional morphology detection device 1 of the present disclosure can precisely measure the three-dimensional morphology of the sample 9, in contrast to conventional Michelson-type interferometers. Specifically, referring to FIG. 7 to FIG. 10, FIG. 7 is a measurement signal diagram of the three-dimensional morphology detection device in FIG. 5 when measuring the TSV sample, FIG. 8 is a measurement result diagram derived from the analysis of the measurement signal in FIG. 7, FIG. 9 is a measurement signal diagram of a conventional Michelson-type interferometer when measuring the TSV sample, and FIG. 10 is a measurement result diagram derived from the analysis of the measurement signal in FIG. 9. FIG. 7 and FIG. 9 illustrate the measurement signals for one of the TSVs V1 of the TSV sample S1, while FIG. 8 and FIG. 10 illustrate the measurement results for one row of TSVs V1 of the TSV sample S1.

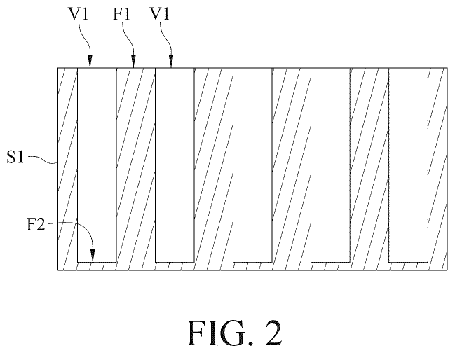

Corresponding to FIG. 7, the sample has a hole width of 5 um and a hole depth of 45 um (or referred to as a depth-to-width ratio of 9:1). The three-dimensional morphology detection device 1 of the disclosure is used to measure a sample with a depth-to-width ratio of 9:1. Based on the detection images obtained by the three-dimensional morphology detection device 1, it can be observed that significant signal intensity variations (corresponding to a depth of approximately 5 um in FIG. 7) are detected on a surrounding surface F1 around the TSV V1 (as shown in FIG. 1 and FIG. 2), and significant and distinguishable signal intensity variations (corresponding to a depth of approximately 49 um in FIG. 7) are detected on a bottom surface F2 of the TSV V1 (as shown in FIG. 2). Subsequently, by analyzing and converting the measurement signals using a transformation tool (e.g., a conversion program or formula), the surface height data of the TSVs at different depths of the TSV sample can be obtained, as shown in FIG. 8. From FIG. 8, it can be seen that the sample S1 has TSVs with hole widths of 10 um and hole depths of 50 um (or referred to as a depth-to-width ratio of 5:1). The three-dimensional morphology detection device 1 of the disclosure inspects the TSV sample S1 with a depth-to-width ratio of 5:1 by directing a parallel sample light to the TSV sample S1. As a result, the sample light can directly enter the high aspect ratio structure and reach the bottom of a narrow structure of the TSV sample S1. Upon reflection, the sample light generates high-intensity interference signals with the reference light, enhancing image contrast and preventing the limitations imposed by the numerical aperture of the objective lens, which allows for precise measurement of clear and distinguishable depth of the TSVs V1 and improves the measurement speed.

As a comparison example, a conventional Michelson-type interferometer is used to measure the same sample (i.e., a TSV sample having TSVs with hole widths of 10 micrometers and hole depths of 50 micrometers). As shown in FIG. 9, the conventional Michelson-type interferometer detects significant signal intensity variations (corresponding to a depth of approximately 5 um in FIG. 9) on the surrounding surface F1 around the TSV V1 (as shown in FIG. 1 and FIG. 2). However, no significant signal intensity variations are observed at other depths. Subsequently, the measurement signals are analyzed and transformed using a conversion tool (e.g., a conversion program or formula) to obtain the surface height data of the TSVs at different depths of the TSV sample, as shown in FIG. 10. From FIG. 10, it can be observed that when measuring microstructures with a depth-to-width ratio of 5:1 using a conventional Michelson-type interferometer, the sample light passes through the objective lens and then is directed to the TSV sample S1 as a convergent light beam. As a result, the convergent sample light cannot effectively reach the bottom of a narrow structure of the TSV sample S1, making it impossible to obtain signals from the bottom surface F2 of the TSVs V1. Consequently, the depth of the TSVs V1 cannot be effectively measured by the conventional Michelson-type interferometer.

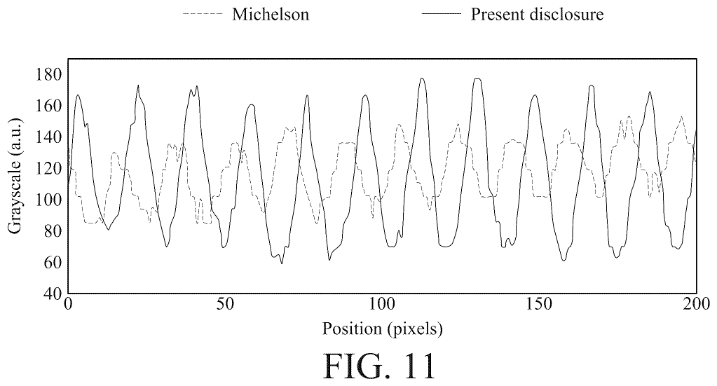

Please refer to FIG. 11, which is a comparison diagram of grayscale values of images obtained by measuring the TSV sample using the three-dimensional morphology detection device of the disclosure and the conventional Michelson-type interferometer. FIG. 11 illustrates the grayscale values of one row of TSVs V1 of the TSV sample S1. As shown in FIG. 11, the grayscale difference between the bottom surface F2 of the TSV V1 and the surrounding surface F1 around the TSV V1 in an image obtained by the three-dimensional morphology detection device 1 of the present disclosure is approximately 120. In contrast, the grayscale difference between the bottom surface F2 of the TSV V1 and the surrounding surface F1 around the TSV V1 in an image obtained by the conventional Michelson-type interferometer is approximately 80. This indicates that the image obtained by the three-dimensional morphology detection device 1 of the present disclosure achieves over a 30% improvement in contrast compared to the image obtained by the conventional Michelson-type interferometer. As a result, the three-dimensional morphology detection device 1 can measure the three-dimensional morphology of the sample with greater precision.

According to the three-dimensional morphology detection device and the measurement method for determining depth of high aspect ratio microstructures as described above, since the sample light split from the beam splitter is directly directed to the sample without first passing through the objective lens, which is configured for focusing light, the sample light is substantially a parallel beam. By directing a parallel sample light to the sample, the sample light can effectively reach the bottom of the holes of the sample featuring high aspect ratio microstructures, enabling precise measurement of the three-dimensional morphology of the sample.

In addition, experimental measurement results demonstrate that the three-dimensional morphology detection device of the present disclosure can accurately measure the three-dimensional morphology of high aspect ratio samples with hole widths smaller than 10 micrometers. Experimental validation further confirms that the three-dimensional morphology detection device of the present disclosure can precisely measure the three-dimensional morphology of high aspect ratio samples with hole widths smaller than 5 micrometers, and even down to 1 micrometer. In contrast, conventional Michelson-type interferometers are limited to measuring the three-dimensional morphology of high aspect ratio samples with hole widths larger than 15 micrometers. Accordingly, the three-dimensional morphology detection device of the present disclosure can measure the three-dimensional morphology of samples with significantly greater precision compared to conventional Michelson-type interferometers.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A three-dimensional morphology detection device configured to inspect a three-dimensional morphology of a sample, the three-dimensional morphology detection device comprising a photosensitive element and a measurement mechanism, the photosensitive element configured to provide detection images of the sample, and the measurement mechanism configured to provide a sample light to the sample to achieve three-dimensional morphology imaging of the sample onto the photosensitive element, wherein the measurement mechanism comprises:
an objective lens configured to converge light and provide detection images of the sample to the photosensitive element;
a beam splitter located between the objective lens and the sample and configured to split a collimated light beam into a reference light and the sample light and to superimpose phases of the reference light after reflection and the sample light reflected from the sample, thereby introducing interference fringes in the detection images of the sample;
a detection light source, wherein the detection light source and the objective lens are located on two adjacent sides of the beam splitter;
a beam collimating element located between the detection light source and the beam splitter and configured to collimate a light beam emitted by the detection light source; and
a light reflecting element, wherein the light reflecting element and the detection light source are located on opposite sides of the beam splitter, and the light reflecting element is configured to reflect the reference light for reception by the beam splitter.

2. The three-dimensional morphology detection device according to claim 1, wherein the sample light is a parallel beam or the sample light has a convergence angle of less than 7 degrees.

3. The three-dimensional morphology detection device according to claim 1, further comprising a tube lens located between the objective lens and the photosensitive element.

4. The three-dimensional morphology detection device according to claim 1, wherein the objective lens is a microscope objective lens, and a numerical aperture of the objective lens ranges from 0.1 to 1.4.

5. The three-dimensional morphology detection device according to claim 1, wherein the detection light source is a detection broadband light source, and the light beam from the detection light source is a broadband white light or a broadband light of other wavelength ranges.

6. The three-dimensional morphology detection device according to claim 1, wherein the beam splitter is a cube beam splitter or a plate beam splitter.

7. The three-dimensional morphology detection device according to claim 1, wherein the beam collimating element is an aspherical mirror or a multifaceted mirror collimator.

8. The three-dimensional morphology detection device according to claim 1, wherein the light reflecting element is a reference surface reflector.

9. The three-dimensional morphology detection device according to claim 1, wherein the photosensitive element is a charge-coupled device sensor array or a complementary metal-oxide-semiconductor sensor array.

10. A measurement method for determining depth of high aspect ratio microstructures comprising:
directing the sample light of the three-dimensional morphology detection device as described in claim 1 to a sample;
positioning the sample on a focal plane of the three-dimensional morphology detection device and adjusting an image formed on the photosensitive element to display interference fringes;
performing vertical scanning by moving the three-dimensional morphology detection device along Z-axis using a piezoelectric transducer; and
analyzing the interference fringes of images captured at various depths along Z-axis to obtain surface height data of microstructures at different depths of the sample;
wherein the sample light that is directed to the sample has a convergence angle of less than 7 degrees.

11. A three-dimensional morphology detection device comprising:
a detection light source configured to provide a light beam;
a beam collimating element configured to collimate the light beam from the detection light source;
a beam splitter configured to split a collimated light beam into a reflected light beam and a transmitted light beam and to receive a sample light traveling in an opposite direction to the reflected light beam and a reference light traveling in an opposite direction to the transmitted light beam;
a light reflecting element configured to reflect the transmitted light beam and provide the reference light;
an objective lens configured to transmit the sample light; and
a photosensitive element configured to receive the sample light from the objective lens to provide a detection image of a sample, and the detection image displaying interference fringes, wherein
the detection light source, the beam collimating element, the beam splitter and the light reflecting element are arranged in a same horizontal direction, the objective lens is arranged between the photosensitive element and the beam splitter in a vertical direction, and the vertical direction is perpendicular to the horizontal direction.

12. The three-dimensional morphology detection device according to claim 11, further comprising a tube lens configured to compensate for the sample light from the objective lens, and then transmit the sample light after compensation to the photosensitive element.

13. The three-dimensional morphology detection device according to claim 12, wherein the tube lens is arranged between the photosensitive element and the objective lens in the vertical direction.

14. The three-dimensional morphology detection device according to claim 11, wherein the sample light is a parallel beam or the sample light has a convergence angle of less than 7 degrees.

15. The three-dimensional morphology detection device according to claim 11, wherein the objective lens is a microscope objective lens, and a numerical aperture of the objective lens ranges from 0.1 to 1.4.

16. The three-dimensional morphology detection device according to claim 11, wherein the detection light source is a detection broadband light source, and the light beam from the detection light source is a broadband white light or a broadband light of other wavelength ranges.

17. The three-dimensional morphology detection device according to claim 11, wherein the beam splitter is a cube beam splitter or a plate beam splitter.

18. The three-dimensional morphology detection device according to claim 11, wherein the beam collimating element is an aspherical mirror or a multifaceted mirror collimator.

19. The three-dimensional morphology detection device according to claim 11, wherein the light reflecting element is a reference surface reflector.

20. The three-dimensional morphology detection device according to claim 11, wherein the photosensitive element is a charge-coupled device sensor array or a complementary metal-oxide-semiconductor sensor array.
